(19) United States
(12) Patent Application Publication
(10) Pub. No.: US 2008/0203269 A1
(43) Pub. Date: Aug. 28, 2008

(54) MAGNETIC STEP PINS ASSEMBLY AND METHOD OF INSTALLATION

(75) Inventors: David S. Jablonsky, Northbrook, IL (US); Ted Kegeris, Fairland, IN (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: JVI MAGNETICS, INC., Fountaintown, IN (US)

(21) Appl. No.: 12/034,281

(22) Filed: Feb. 20, 2008

Related U.S. Application Data
(60) Provisional application No. 60/890,697, filed on Feb. 20, 2007.

(51) Int. Cl. B28B 7/22

(52) U.S. Cl. 249/14; 182/87

(57) ABSTRACT

A magnetic step pin assembly for a concrete structure including an elongated plate having at least one magnet installed on a first side of the plate and at least two step pin pegs extending from a second side of the plate, and a plurality of cam pins for insertion into holes formed by the at least two step pin pegs, thereby forming a ladder for the concrete structure.

### CROSS-REFERENCE TO RELATED APPLICATIONS

This application claims priority of U.S. Provisional Patent Application No. 60/890,697, filed Feb. 20, 2007, in the United States Patent and Trademark Office, the disclosure of which is incorporated herein by reference in its entirety.

### BACKGROUND OF THE INVENTION

1. Field of the Invention

The present general inventive concept relates generally to a magnetic step pin assembly, and more particularly, to a magnetic step pin assembly for use in the concrete structures to form a ladder within manholes, catch basins, and the like.

2. Description of the Related Art

A manhole may be fabricated in various diameters and heights and is installed in a hole in the ground and stacked to various heights depending on application. To access the manhole, steps are required to enable a worker to climb up or down the manhole. Other concrete structures, such as catch basins, also require steps to enable access thereto. Concrete structures typically have either flat or concave concrete walls.

The construction industry typically installs steps in a concrete structure by forming step holes in a concrete wall thereof. There are various known methods by which step holes can be created for manholes, or other flat or curved wall concrete structures.

One method by which manhole steps can be made utilizes holes located in a steel core at standard locations. Before concrete is poured, a worker must climb under the steel core and insert individual step pegs through the holes to create a step pin cavity. After the concrete is poured and cured, the worker must climb back in and remove the individual step pegs. This method is time consuming, is difficult to implement, and has decreased adaptability as the method does not allow repositioning of the step pegs because the step pin cavities are fixed and cannot be moved.

Another method to create manhole steps also utilizes holes located in a steel core at standard locations. A cam rotor is located inside the core and has the needed step pegs to be pushed through the holes. Before the concrete is poured, a worker will rotate the cam in a first direction to push the pegs through the holes. After the concrete is poured and cured, a worker will rotate the cam in a second direction different than the first direction and the pegs will collapse back into the core. This method requires additional processes to maintain the cam system and thereby increases costs to implement the method. An additional disadvantage is the method's lack of adaptability as the method does not allow repositioning of the step pegs because the step pin cavities are fixed and cannot be moved.

Yet another method to create manhole steps does not utilize holes located in the concrete prior to pour. Instead, holes are created after the product is made by drilling the holes into the concrete. This method is time consuming and requires specific adherence to tolerances, which increases costs of implementation because it is difficult to drill offset holes to specific tolerances, e.g., drilling depth. This method also presents a safety hazard because it is possible that the steps may pull out of the concrete if the tolerances are not maintained.

Other methods exist that do not use step pins. One method in particular utilizes a permanent ladder system as an alternative to step pins. This type of method is typically utilized on flat wall concrete products. A ladder is screwed onto the wall after the product is installed in the ground. Because drilling is required after curing of the concrete, this method is time consuming and requires specific adherence to tolerances, which increases costs of implementation because it is difficult to drill offset holes to specific tolerances, e.g., drilling depth. Safety is also a concern because the ladder may pull out of the concrete if the tolerances are not maintained.

Therefore, it would be beneficial to provide a step pin assembly that is less costly and facilitates installation of steps for a manhole thereby increasing efficiency. It would also be beneficial to provide a step pin assembly to create steps for a manhole with increased adaptability for step placement and with increased safety.

### SUMMARY OF THE INVENTION

The present general inventive concept provides a magnetic step pin assembly that utilizes a method for installing steps in a manhole that has increased efficiency and is less costly.

The present general inventive concept also provides a method of installing step pin in a manhole or other flat wall concrete product that is safer with increased adaptability because the method allows repositioning of the steps.

The foregoing and/or other aspects and utilities of the present general inventive concept may be achieved by providing a magnetic step pin assembly and installation method thereof.

The foregoing and/or other aspects and utilities of the present general inventive concept are intended to be illustrative of the general inventive concept and are not meant in a limiting sense. Many possible embodiments of the general inventive concept may be made and will be readily evident upon a study of the following specification and accompanying drawings comprising a part thereof. Various features and subcombinations of the general inventive concept may be employed without reference to other features and subcombinations. Other objects and advantages of this general inventive concept will become apparent from the following description taken in connection with the accompanying drawings, wherein set forth by way of illustration and example, one or more embodiments of this general inventive concept and various features thereof.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a picture of a magnetic step pin assembly illustrating an exemplary embodiment of the present general inventive concept showing a plate, two step pin pegs, and a plurality of magnets (the magnets are located within the holes shown in the surface of the plate).

FIG. 2 is a picture of the magnetic step pin assembly of FIG. 1 showing the front side of the assembly with the plate and the two step pin pegs shown.

FIG. 3 is a drawing of the magnetic step pin assembly of FIG. 1 showing the step pin peg and illustrating the location of the assembly within a form.

FIG. 4 is a drawing of the magnetic step pin assembly of FIG. 1 showing the top, side and bottom view of the assembly wherein the plate is flat.

FIG. 5 is a drawing of the magnetic step pin assembly of FIG. 1 showing the top, side and bottom view of the assembly wherein the plate is curved.

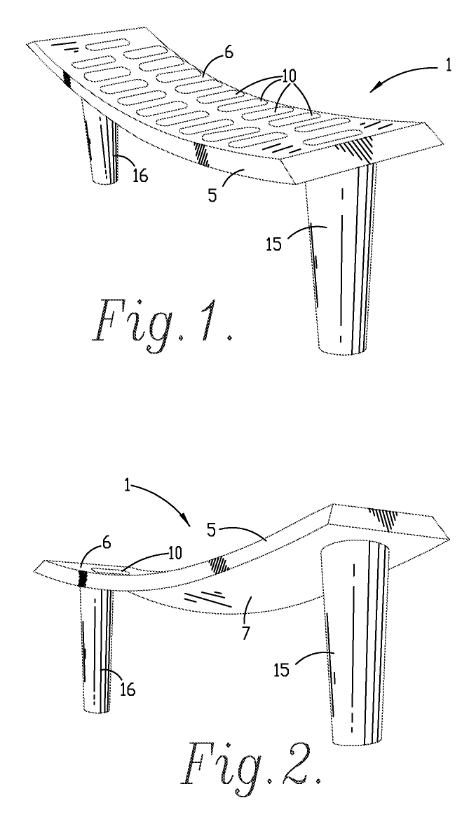

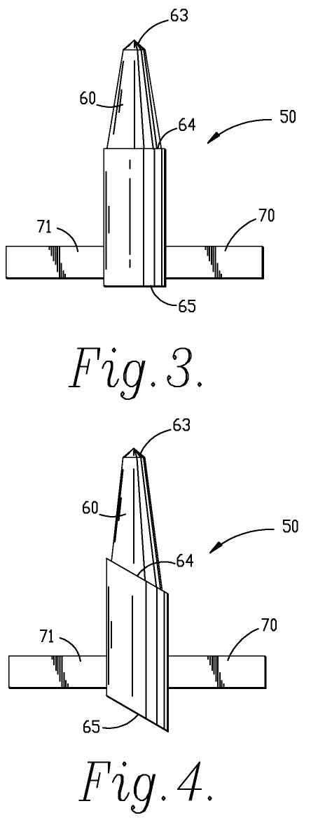

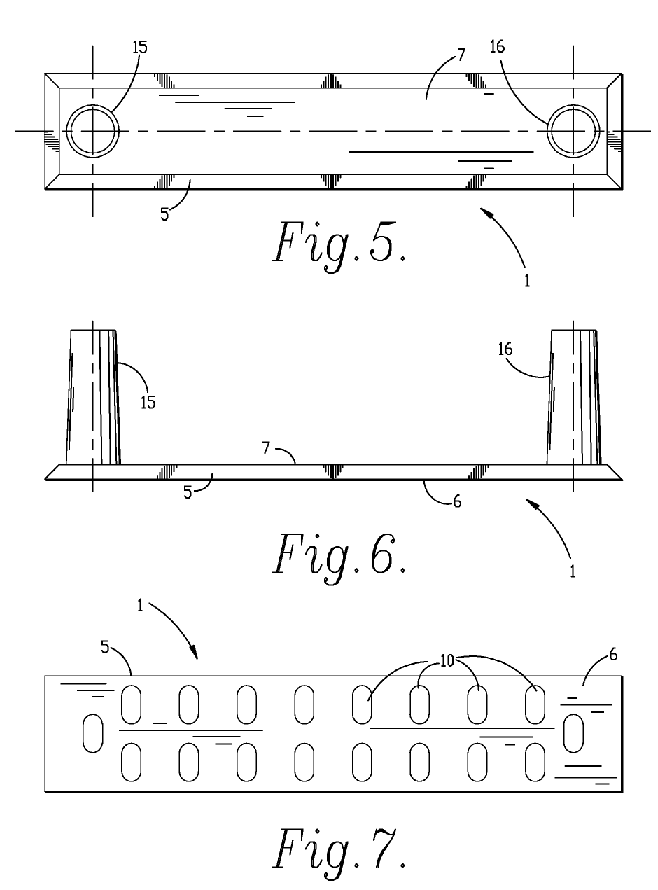

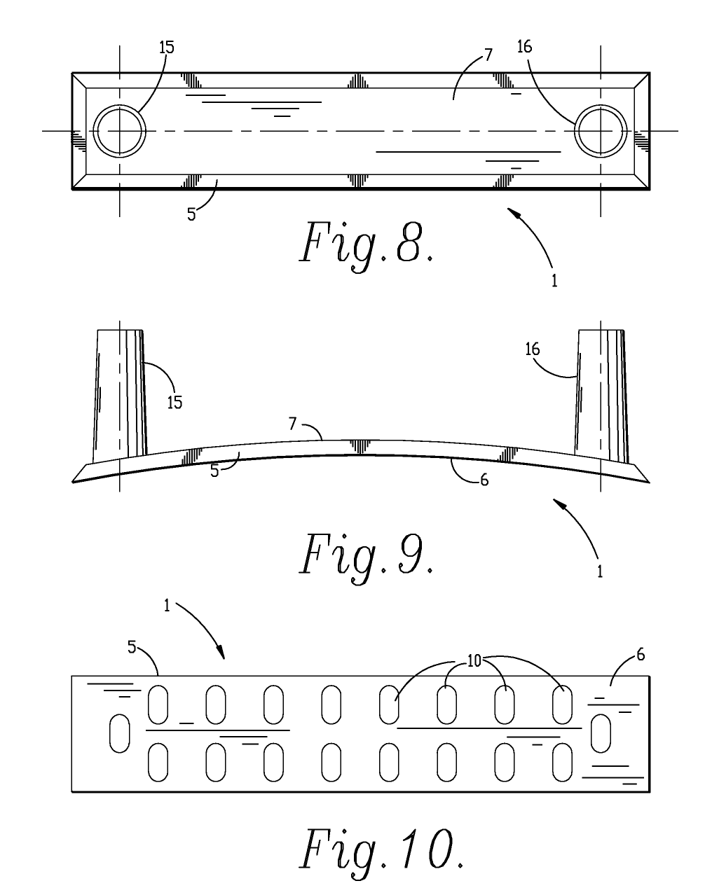

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 1 illustrates a step pin assembly 1 according to an exemplary embodiment. The step pin assembly 1 includes a generally rectangular plate 5 with a plurality of magnets 10 installed on a back side 6 of the plate 5 and at least two step pin pegs 15 and 16 extending out from a front side 7.

In the exemplary embodiment, the plate 5 is made of steel and is generally planar. It is foreseen, however, that the plate 5 may be made of aluminum, plastic, urethane, other like material, or combination thereof. Further, the plate 5 may be sized and/or shaped depending on the desired configuration of the step pin assembly 1 to conform to a mounting surface (not illustrated).

For example, the generally planar plate 5 of the exemplary embodiment is flat for use, for example, with a flat wall concrete product (not illustrated). In another embodiment, the plate 5 is curved for use, for example, with a concave manhole concrete form (not illustrated). Regardless of the shape of the plate 5, the pins 15 and 16 extend away from a front side 7 of the plate 5 in a direction parallel to each other as illustrated in the Figs.

The magnets 10 are located along the back side 6 of the plate 5. The quantity and size of the magnets 10 vary depending on the intended application of the step pin assembly 1. Such factors may include support strength required. If an application demands relatively high support strength, the step pin assembly 1 requires larger and/or an increased number of magnets 10 relative to applications demanding low support strength.

The two step pin pegs 15 and 16 are made of steel in the exemplary embodiment, but may be made of aluminum, plastic, urethane, other like material, or combination thereof. The step pin pegs 15 and 16 may be manufactured in various lengths, diameters, and tapers depending on the application of the step pin assembly 1.

The step pin pegs 15 and 16 may be attached to the plate 5 and offset with respect to each other at consistent or varying distances depending on the application of the step pin assembly 1. The step pin pegs 15 and 16 may be attached to the front side 7 of the plate 5 by welding, screwing, or other like means for coupling. In the exemplary embodiment, the step pin pegs 15 and 16 are removably attached to the plate 5 via screws 20 and 21 to provide increased versatility. Step pin pegs 15 and 16 that are removable allow installation of step pin pegs 15 and 16 of varying shapes, sizes, and/or lengths so that the step pin assembly may be adapted to fit a plurality of applications.

In the exemplary embodiment, the step pin assembly 1 is used in the concrete industry to form preformed holes in the concrete after the concrete has hardened and cured. Although it is foreseen that the step pin assembly 1 may be employed with any type of concrete structure that requires holes in concrete walls thereof, examples of ideal applications include manholes or catch basin applications wherein the step pin assembly 1 may be installed for use as a ladder.

The step pin assembly 1 is used substantially the same regardless of whether it is installed in a manhole having a curved side wall, a catch basin having a flat side wall, or other like concrete structure.

Also illustrated is a cam pin 50 for steps. The cam pin is generally T-shaped and has a tapered pin 60, a sleeve 62, and handles 70 and 71 that extend outward on either side of the sleeve 62. The pin 60 has a point 63 to provide additional anchoring upon installation of the cam pin 50.

The sleeve 62 has an abutment surface 64 adjacent to the pin 60 and an outer surface 65 opposite thereto. The abutment surface 64 and/or the outer surface 65 may be angled or flat depending on application.

In the exemplary embodiment, the plate 5 is 15 inches long, 3 inches wide, and 0.375 inches thick. The plate 5 has a 45 degree chamfer draft on end surfaces 8 and 9 and side surfaces 11 and 12. Centers of the pins 15 and 16 are situated 1 inch from the end surfaces 8 and 9 and 1.5 inches from the side surfaces 11 and 12 of the plate 5. Pins 15 and 16 are 3.5 inches long and taper from a first end 17 that is 1.140625 (1 9/64) inches in diameter to a second end that engages the plate 5, the second end having a diameter of 1.333333 (1 3/9) inches. Magnets 10 installed on the back side 6 of the plate 5 are 1 by 0.5 inches and are situated 0.5 inch from a center of the plate 5 with every magnet 10 being 1 inch apart along a length of the plate 5 and 0.5 inches apart along a width of the plate 5.

The cam pin 50 is 6.9375 inches long and 7.625 inches wide. The pin 60 is 3.5 inches long and tapers inward from the sleeve 62 toward the point 63. At the sleeve 62, the pin 60 is 1.09375 inches in diameter. At the point 63, the pin 60 is 0.875 inches. Because the cam pin 50 comes in varying sizes (pin 60 diameters and/or sleeve 62 angles, the cam pin 50 may be color coded to easily distinguish between different diameters and angles to facilitate proper selection.

In use, the plate 5 is placed on a steel core form side at predetermined location holes. Concrete is poured around the plate 5 and pins 15 and 16 and allowed to cure thereby forming a concrete structure. The concrete structure, such as a manhole, is removed from the steel core form. As the concrete structure is removed, the plate 5 is forced to slide along the steel core form because the pins 15 and 16 are embedded in the concrete structure. The plate 5 and pins 15 and 16 are then pulled out of the concrete structure to expose holes formed by the pins 15 and 16.

The user then selects the cam pin 50 based on two factors. First, the user determines whether the sleeve 62 must be angled or flat to conform to the concrete structure. Determining the proper sleeve shape allows the user to install a plurality of cam pins 50 having handles 70 and 71 that are parallel to each other. In this manner, a plurality of cam pins 50 may coordinate with each other to form either side of a ladder. Second, the user determines hole size formed by either pin 15 and 16 to enable selection of an appropriately sized pin 60 to conform to the hole. It is important to closely match the pin 60 with the hole to provide a snug and secure fit, thus decreasing the likelihood of inadvertent removal of the cam pin 50 from the hole and increasing safety.

After selecting an ideal cam pin 50, the cam pin 50 may be inserted into the hole via the pin 60 to form a step or series of steps to form a ladder.

Having now described the features, discoveries and principles of the general inventive concept, the manner in which the general inventive concept is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the general inventive concept herein described, and all statements of the scope of the general inventive concept which, as a matter of language, might be said to fall therebetween.

What is claimed is:

1. A magnetic step pin assembly comprising:
an elongated plate including at least one magnet installed on a first side of the plate and at least two step pin pegs extending from a second side of the plate; and
at least two cam pins having a pin, a handle with either an angled sleeve or a flat sleeve, and a handle.

2. The magnetic step pin assembly according to claim 1, wherein the first side of the plate is opposite to the second side of the plate.

3. The magnetic step pin assembly according to claim 1, wherein the first side of the plate is parallel to the second side of the plate.

4. The magnetic step pin assembly according to claim 1, wherein the first side of the plate and the second side of the plate are flat and extend along a single plane.

5. The magnetic step pin assembly according to claim 1, wherein the first side of the plate is concave and the second side of the plate is convex.

6. The magnetic step pin assembly according to claim 1, further comprising:
a point on each pin of the at least two cam pins.

7. The magnetic step pin assembly according to claim 1, wherein if the first side of the plate is concave then each sleeve of the at least two cam pins is angled.

8. A method for using a magnetic step pin assembly, the method comprising the steps of:
providing a magnetic step pin assembly having a plurality of protrusions extending from a surface of a plate of the magnetic step pin assembly;
magnetically attaching the plate of the magnetic step pin assembly onto a form;
pouring concrete around the form and the plate of the magnetic step pin assembly;
removing the concrete from the form when the concrete has cured;
removing the plate of the magnetic step pin assembly from the concrete to expose a plurality of holes formed by the plurality of protrusions;
inserting a cam pin of the magnetic step pin in each of the plurality of holes, the cam pin having a handle and a sleeve.

9. The method of using the magnetic step pin assembly according to claim 8, wherein the sleeve has one of an angled abutment surface and a flat abutment surface.

10. The method of using the magnetic step pin assembly according to claim 8, wherein the surface of the plate has either a curved surface or a flat surface.

11. The method of using the magnetic step pin assembly according to claim 8, wherein if the surface of the plate is concave, then each sleeve of the at least two cam pins has an angled abutment surface.

12. The method of using the magnetic step pin assembly according to claim 8, wherein if the concrete has a curved side wall, then the surface of the plate is concave and each sleeve of the at least two cam pins has an angled abutment surface to conform to the side wall of the concrete.
